(19) United States
(12) Patent Application Publication
(10) Pub. No.: US 2008/0057381 A1
(43) Pub. Date: Mar. 6, 2008

(54) Dissolved-fuel direct alcohol fuel cell

(76) Inventors: Bor Z. Jang, Centerville, OH (US); Aruna Zhamu, Centerville, OH (US); Jiusheng Guo, Centerville, OH (US)

Correspondence Address: Bor Z. Jang, 9436 Parkside Drive, Centerville, OH, 45458, US

(21) Appl. No.: 11/515,340

(22) Filed: Sep. 5, 2006

(51) Int. Cl. H01M 8/08; H01M 4/90; H01M 8/24; H01M 4/92

(52) U.S. Cl. 429/46; 429/40; 429/38

(57) ABSTRACT

The present invention provides a light-weight, compact fuel cell that is well-suited to powering portable electronic devices and vehicles, particularly light-duty vehicles such as golf carts, forklifts, wheelchairs, motor bikes, and scooters. The fuel cell comprises the following major components: (a) a fuel anode; (b) an oxidant cathode comprising an alcohol-tolerant oxidant reduction catalyst; and (c) a liquid electrolyte in ionic contact with the anode and the cathode with the electrolyte comprising a solution and an alcohol fuel dissolved in the solution. The presently invented dissolved-fuel direct alcohol fuel cell eliminates the use of expensive polymer electrolyte membranes and, in general, do not require the use of expensive platinum as a catalyst material at the cathode and/or at the anode. The alcohol fuel may be selected from methanol, ethanol, propanol, isopropanol, formic acid, or a combination thereof. The electrolyte may comprise an acid or an alkaline solution.

### FIELD OF THE INVENTION

This invention relates to a direct alcohol fuel cell (DAFC), particularly direct methanol fuel cell (DMFC), direct ethanol fuel cell (DEFC), direct 2-propanol fuel cell (D2PFC), and direct formic acid fuel cell (DFAFC). In particular, this invention provides a dissolved-fuel DAFC that operates on an alcohol fuel dissolved in an electrolyte fluid.

### BACKGROUND OF THE INVENTION

A particularly useful fuel cell for powering portable electronic devices and light-duty vehicles is a direct methanol fuel cell (DMFC) in which the fuel is a liquid methanol/water mixture and the oxidant is air or oxygen. Protons are formed by oxidation of methanol and water at the anode (fuel electrode). Protons then pass from the anode through a solid proton-exchange membrane (PEM) to the cathode (oxidant electrode). Electrons produced at the anode in the oxidation reaction flow in the external circuit to the cathode where they combine with protons and oxygen to produce water as a byproduct.

The electrochemical reactions occurring in a conventional direct methanol fuel cell which contains an acid electrolyte may be illustrated as follows:

Anode: CH₃OH+H₂O→CO₂+6H⁺+6e⁻ (1)

Cathode: 3/2O₂+6H⁺+6e→3H₂O (2)

Overall: CH₃OH+3/2O₂→CO₂+2 H₂O (3)

The DMFC and other proton-exchange membrane fuel cells (PEMFCs) typically use a hydrated sheet of a perfluorinated acid-based ionomer membrane as a solid electrolyte. The proton exchange membrane is known to be extremely expensive and its cost represents a significant portion of the overall cost of a fuel cell system. The electrodes, each typically containing a catalyst phase (usually a thin layer of platinum or platinum/ruthenium catalyst which is also extremely expensive), are intimately bonded to two primary sides of the membrane. This membrane is commercially available from DuPont (under the trade name Nafion®), among several other suppliers. Typically, proton exchange membranes are polymeric in nature and have finite life cycles due to their inherent chemical and thermal instabilities. Such membranes typically exhibit relatively poor mechanical properties at high temperatures and pressures, which seriously limits their range of use. They also undergo irreversible degradation reactions at high temperatures.

In addition to high PEM material and platinum catalyst costs, conventional DMFCs are commonly recognized to have the problem of low fuel utilization efficiency due to methanol crossover from the anode through the electrolyte membrane to the cathode. The methanol that crosses over to the cathode reacts at the cathode, not only competing with the oxygen reduction reaction for active catalyst surface sites but also producing the “mixed potential” effect (depolarization loss) that aversely impacts the voltage output of the fuel cell. For these reasons, over the past 15 years, a tremendous amount of research and development efforts worldwide has been spent in trying to reduce methanol crossover or mitigate its negative effects. These efforts include modifications of existing PEM materials, addition of functional materials to the PEM, development of new PEM chemistries, utilization of vaporous fuel, increase of Pt loadings at the anode, and discovery of methanol-tolerant oxidant reduction catalysts. Good progress has been made in all of the aforementioned areas, but the progress has been incremental and these issues still remain to be the hurdles to full commercialization of DMFCs.

It is of particular interest to note that, in the aforementioned efforts, the methanol-tolerant catalysts were developed for the purpose of reducing the mixed potential effect of methanol that migrated through the solid polymer electrolyte or proton exchange membrane (PEM) of a conventionally configured DMFC. Examples are given in Zhu, et al. (“Methanol-Tolerant Cathode Catalyst Composite for Direct Methanol Fuel Cell,” U.S. Pat. No. 7,014,931, Mar. 21, 2006) and K. Sawai, et al., (“Heat-Treated Transition Metal Hexacyanometallates as Electrocatalysts for Oxygen Reduction Insensitive to Methanol,” Journal of The Electrochemical Society, 151 (5) (2004) A682-A688). No attempt was made to eliminate the utilization of a solid PEM (which is very expensive) in a DMFC by replacing it with a liquid electrolyte since a liquid electrolyte would be believed to allow for an even more severe methanol crossover problem. Contrary to this conventional wisdom, we have found that, by using a liquid electrolyte containing dissolved fuel (e.g. methanol or ethanol dissolved in a selected acid-water solution or an alkaline solution), one could make a much simpler fuel cell stack that has fewer layers and also can be more easily assembled and sealed. In this design, the fuel-electrolyte mixture is interposed between the anode and cathode layer (no solid electrolyte membrane is needed). The fuel is fed directly into the space between the anode and the cathode and, hence, the manifolding and flow channels commonly used at the anode side of a bipolar plate are no longer needed. By judiciously using methanol-tolerant catalysts, we did not see any more detrimental effect associated with the presumably more methanol at the cathode side of a dissolved-fuel fuel cell compared to that of a conventional DMFC.

More significantly, we have also surprisingly found that many of these methanol-tolerant catalysts are actually tolerant to other alcohols such as ethanol, propanol, iso-propanol, and formic acid. Formic acid, with a chemical formula HCOOH, may also be considered as an alcohol (with an —OH group). Still more surprisingly, these catalysts also work well for both acidic and basic (alkaline) electrolyte environments, paving the ways for many new and more efficient direct alcohol fuel cell designs or configurations.

It may be further noted that a conventional DMFC stack comprises a plurality of single fuel cell units with each unit consisting of a part of a bipolar plate (one surface containing fuel transport channels), a fluid diffusion member (e.g., carbon paper), an anode catalyst layer, a proton exchange membrane layer, a cathode catalyst layer, a gas diffusion layer (e.g., Teflon-treated carbon paper), and typically the other part of the same bipolar plate (the opposite surface containing oxidant transport channels). These units are stacked together with peripheral areas properly sealed to prevent fuel or oxidant leakage. These conventional DMFC systems have too many layers in the structure and they require complex manifolding to supply a fluid fuel to the anode (through the fluid channels of an anode separator) and supply an oxidant fluid (air or oxygen flow) to the cathode (through the flow channels of a cathode separator). The two separators may be integrated into a bipolar plate which has flow channels on both sides. More complex manifolding also means greater difficulty in sealing the fuel cell stack from leaking. It would be highly advantageous from fuel cell design and manufacturing ease/cost perspectives to have a simpler separator or bipolar plate (containing flow channels on one side only) that are thinner, resulting in a simpler, thinner, and lighter-weight fuel cell stack. It would be further advantageous to eliminate the bipolar plates all together. It would be most desirable if the bipolar plates are eliminated and the manifold is also minimized or eliminated.

The presently invented dissolved-fuel direct-alcohol fuel cell (DF-DAFC) operates on a fuel dissolved in a liquid electrolyte (normally containing no oxidant). The DF-DAFC is fundamentally different and distinct from the conventional mixed-reactant fuel cell, the latter operating on a mixture of fuel and oxidant (for solid oxide fuel cells only) or a mixture of fuel, oxidant, and electrolyte. For instance, Priestnall, et al. (US 2004/0058203, pub. date Mar. 25, 2004 and US 2003/0165727, pub. date Sep. 4, 2003) recently disclosed a mixed-reactant fuel cell in which the fuel (methanol or sodium boron hydride), the electrolyte (KOH), and oxygen are mixed together. In one embodiment, the mixed reactant solution was directed to flow from a first anode down through a first cathode, then through a second anode and second cathode, etc. A fuel cell of this type has several severe drawbacks:
(1) Since the anode is surrounded by not just fuel species, but also electrolyte and oxidant, the anode catalyst must meet highly demanding conditions (must be highly selective). This is in addition to the requirement that the cathode catalyst must be tolerant to both the fuel and the electrolyte.
(2) The solubility of oxygen in most fluid is extremely limited. By immersing the cathode in an oxygen-containing fluid, the amount of oxygen that can come in contact with the cathode catalyst surface is very low, much lower than what can be achieved with a highly concentrated oxygen flow or air flow that is focused to directly impinge upon the catalyst surface. The highly diluted oxygen species are uniformly distributed everywhere in the fuel-electrolyte-oxidant mixture solution and can not be effectively attracted specifically to the cathode catalyst. Consequently, the output current density of such a mixed-reactant fuel cell is extremely low. It may be further noted that the so-called “three-phase” interface area (where liquid electrolyte meets oxygen gas molecules on a solid catalyst surface) is a critically important factor in terms of generating a good current density. The fuel cell design of Priestnall, et al. appears to be against the fundamental principles of fuel cells.
   For these reasons, the cell voltages are not high (exhibiting a useful voltage only over a very narrow range of low current densities) and the measurable currents are very low. Consequently, the overall power densities (in terms of mW/cm²) are too low for these fuel cells to have any practical utility value.

Therefore, one object of the present invention was to provide a simpler configuration for a direct alcohol fuel cell.

A specific object of the present invention was to provide a fuel cell that operates on a liquid or solution-based electrolyte containing a fuel such as methanol, ethanol, propanol, iso-propanol, and formic acid dissolved in the electrolyte solution.

A further specific object of the present invention was to provide a fuel cell stack that has fewer layers and could be more easily assembled and sealed.

Another object of the present invention was to provide a fuel cell that does not depend upon expensive solid electrolyte membrane or platinum catalyst materials for its operation.

Still another object of the present invention was to provide a direct alcohol fuel cell that works on a wide variety of electrolyte materials, both acidic and basic.

Another object of the present invention was to provide a fuel cell that delivers a high voltage and/or high power density.

### BRIEF SUMMARY OF THE INVENTION

The present invention provides a light-weight, compact fuel cell that is well-suited to powering portable electronic devices and vehicles, particularly light-duty vehicles such as golf carts, forklifts, wheelchairs, motor bikes, and scooters. The fuel cell comprises the following major components: (a) a fuel anode; (b) a first oxidant cathode comprising an alcohol-tolerant oxidant reduction catalyst; and (c) a liquid electrolyte in ionic contact with the anode and the first cathode, the electrolyte comprising a solution and an alcohol fuel dissolved in the solution. The alcohol fuel is methanol, ethanol, propanol, formic acid, isopropanol (2-propanol), or a combination thereof.

The electrolyte solution may comprise an acid or alkaline solution. The alkaline solution is preferably selected from the group consisting of KOH, NaOH, LiOH, and combinations thereof. The acid electrolyte may be selected from phosphoric acid, sulfuric acid, sulfonic acid, nitric acid, hydrogen chloride, formic acid, or a combination thereof. In a more preferred mode, the electrolyte solution comprises an alkaline solution and the alcohol fuel comprises a methanol, ethanol, or 2-propanol. A matrix of porous material may be used to assist in retaining the liquid electrolyte to avoid the situation of the electrolyte solution flooding the pores in the cathode. It may also assist in supplying fuel/electrolyte to the fuel cell from a source via capillarity.

The alcohol-tolerant oxidant reduction catalyst may comprise a catalyst selected from a platinum-chromium alloy, platinum-vanadium alloy, a transition metal mixture or alloy in the form of nano-scaled particles (preferably smaller than 2 nm in size and particularly those obtained from transition metal hexacyanometallate) dispersed on carbon black, a carbon-supported iron and/or cobalt, a MoₓRu_{y}Se_{z}—(CO)ₙ carbonyl cluster, a Ru—Se mixed metal, or a combination thereof. Most of these cathode catalysts were found to be insensitive to the presence of methanol in a solid acid environment; i.e., with a Nafion-type solid acid electrolyte. No previous report was given on the sensitivity or insensitivity of these catalysts to methanol in an alkaline environment, or to other alcohols in either acid or alkaline environment. Our studies have indicated that, in comparison with Pt, these cathode catalysts are relatively insensitive to all the primary alcohols (e.g., methanol, ethanol, propanol, 2-propanol, and formic acid) in either an acid or alkaline environment. This is a highly significant and non-obvious observation.

In a fuel cell or a stack of fuel cells, an electrolyte and fuel supply/treatment means may be provided for feeding, replenishing, retrieving, re-circulating, or refreshing the electrolyte/fuel. The electrolyte-fuel mixture may be continuously or intermittently circulated between the fuel cell and a fresh tank (or tanks) of fuel and electrolyte. A sensor may be used to monitor the fuel or alcohol concentration.

Another preferred embodiment of the present invention is a planar fuel cell system, comprising a substantially planar array of a plurality of liquid electrolyte chambers (zones or pools), having a plurality of anodes disposed on one major side of the liquid electrolyte zones and a plurality of corresponding cathodes disposed on an opposing major side of the electrolyte zones. In this system, the cathodes comprise an alcohol-tolerant catalyst, the liquid electrolyte is in ionic contact with the anodes and the cathodes, and the electrolyte comprises a solution and an alcohol fuel dissolved in the solution. Preferably, the fuel cell system further comprises a plurality of current collectors each having an interconnect means, wherein each of the plurality of anodes or each of the plurality of cathodes has one of the current collectors associated therewith and the interconnect means is arranged to provide electron transfer between anodes and cathodes. The anodes, cathodes, and interconnect means are arranged in a substantially planar array.

This planar fuel cell system overcomes several shortcomings of prior art fuel cell stacks. For instance, the need to stack several unit fuel cells together normally requires complex flat stack arrangements and involves numerous parts (gaskets, channels, and bipolar plates, etc.) that may be difficult and expensive to fabricate and assemble. The presently invented planar fuel cell system is surprisingly simple in configuration, easy to make, efficient, amenable to miniaturization, and is potentially of extremely low cost.

### BRIEF DESCRIPTION OF THE DRAWINGS

FIG. 1 A cross sectional view of the components of a prior art direct alcohol fuel cell that operates with a solid polymer electrolyte membrane.

FIG. 2 (A) Schematic of a single unit of dissolved-fuel direct alcohol fuel cell (DF-DAFC); and (B) another single unit that has oxidant flow channels in a separator or uni-polar plate.

FIG. 3 A DF-DAFC wherein the anode has two primary catalyst-coated surfaces in contact with the electrolyte-fuel solution. Such a configuration results in a higher current output given the same active cathode area.

FIG. 4 A DF-DAFC wherein the anode and the cathode are separated by a matrix of highly porous, ion-permeable material which is capable of being impregnated with the electrolyte-fuel solution through capillary action.

FIG. 5 A sandwich-type DF-DAFC wherein a fuel anode is placed between two oxygen cathodes. Such a configuration results in a higher current output.

FIG. 6 Schematic of a DF-DAFC wherein a highly ion-permeating dense phase 33 serves to eliminate the contact of an alcohol fuel with the cathode.

FIG. 7 (a) A fuel cell stack comprising a multiplicity of DF-DAFC units featuring a matrix of highly porous material 44 for feeding the electrolyte-fuel mixture via capillarity force; (b) Another fuel cell stack comprising a multiplicity of DF-DAFC units that are equipped with a fuel-electrolyte supplying or treating system (e.g., for providing a circulating electrolyte-fuel); (c) Another fuel cell stack comprising a multiplicity of DF-DAFC units that comprise an anode backing layer with both of its primary surface coated with a catalyst.

FIG. 8 An exploded isometric view (schematic) of a planar fuel cell in accordance with a preferred embodiment of the present invention.

FIG. 9 Cell current-voltage responses (polarization curves) of a DF-DMFC that comprises a methanol-tolerant Pt/Cr cathode catalyst, a conventional DMFC, and a DF-DMFC comprising a conventional cathode catalyst (pure Pt).

FIG. 10 Polarization curves of an acid- and an alkaline-based electrolyte DF-DMFC.

FIG. 11 Performance of dissolved-fuel direct ethanol fuel cells.

FIG. 12 Cell voltage-current density curve of a 2-propanol-based dissolved-fuel FC and that of a corresponding DMFC.

FIG. 13 Polarization curves of a formic acid fuel DF-FAFC-Pa—RuSe, a conventional FAFC, and a methanol fuel DF-DMFC-Pt/Ru (anode)-RuSe (cathode) cell.

FIG. 14 Power density output of a DF-DMFC-Pt/Cr (diamond), DMFC (square), and DF-DMFC-Pt (triangle).

FIG. 15 Power density of a DF-FAFC (formic acid being the main component of the electrolyte as well as the fuel) and a conventional FAFC.

### DETAILED DESCRIPTION OF THE INVENTION

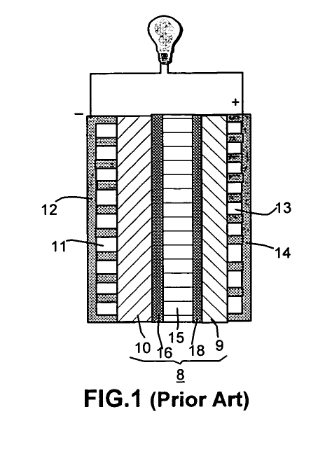

FIG. 1 shows the schematic side view of a prior art direct alcohol fuel cell. This cell comprises a membrane electrode assembly 8, which comprises a proton exchange membrane 15 (PEM), an anode bonded to one face of the PEM 15, and a cathode bonded to the opposite face of PEM. The anode typically includes a platinum/ruthenium electro-catalytic film 16 supported by a backing layer or gas diffusion layer 10 (e.g., carbon paper). The catalytic film or catalyst phase 16 is positioned at the interface between the anode backing layer and PEM 15 for promoting oxidation of the alcohol fuel. Similarly, the cathode preferably includes a backing layer 9 (e.g., carbon paper) and a platinum electro-catalytic film 18 positioned at the interface between the cathode backing layer 9 and PEM 15 for promoting reduction of the oxidant. The fuel cell also comprises a pair of fluid distribution plates 12 and 14, which are positioned on opposite sides of membrane electrode assembly 8. Plate 12, which serves as a fuel distribution plate, is shaped to define fuel channels 11 facing towards anode 10. Channels 11 in Plate 12 are designed to hold a quantity of a liquid mixture of methanol and water. Plate 14 is shaped to include fluid channels 13 for passage of a quantity of gaseous oxygen (or air). Plate 14 is electrically conductive and in electrical contact with the cathode backing layer 9. It can be used as a uni-polar plate (the positive terminal of the electrical current generated by the fuel cell unit) or a part of a bipolar plate.

Furthermore, a fuel cell system is typically composed of a multiplicity of fuel cell units that are stacked together with the negative terminal (e.g., a current collector similar to plate 12) of a unit cell in physical and electronic contact with the positive terminal (e.g., a current collector similar to plate 14) of another unit cell so that effectively the unit cell units are electrically connected in series to form a fuel cell stack. Most typically, Plates 12 and 14 are integrated into a single bipolar plate. There are really too many layers in a conventional DMFC fuel cell stack.

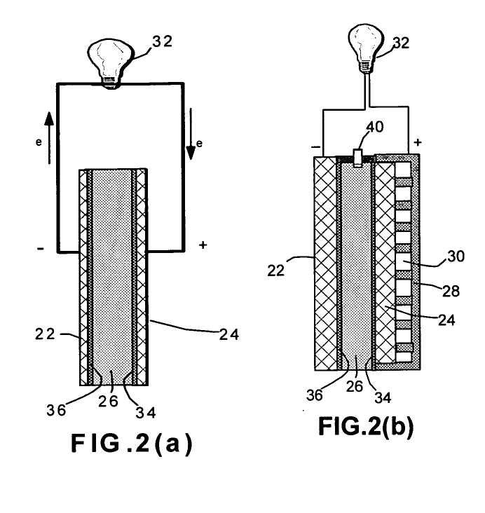

In one preferred embodiment, as illustrated in FIG. 2(a), the present invention provides a dissolved-fuel direct alcohol fuel cell (DF-DAFC) that is primarily composed of (a) a fuel anode 22 (comprising an anode catalyst phase 36); (b) an oxidant reduction cathode 24 (also referred to as the first oxidant cathode) comprising an alcohol-tolerant cathode catalyst phase 34; and (c) a liquid electrolyte 26 in ionic contact with the anode and the cathode with the electrolyte comprising a solution (an alkaline or acid solution) and a fuel dissolved in the electrolyte solution (hereinafter also referred to as an electrolyte-fuel mixture).

The fuel anode 22 is preferably a non-consumable electrode that is electronically conducting so that it may serve two primary functions: (1) as a backing layer or carrier for electro-catalyst 36 that promotes the anode reaction (e.g., Eq.(1) or the like) to produce electrons and (2) as an electron collector through which the produced electrons are transported to an external load (e.g., a bulb 32 in FIG. 2(a)). A highly conducting carbon paper, carbon cloth, or graphite foam plate is a good fuel anode material for practicing the present invention.

The oxidant electrode (cathode) 24 is made of a material selected so that oxygen can be easily engaged in an electro-reduction reaction on its surface. For example, such an electrode may include a carbon paper or cloth, nickel-dispersed carbon paper or cloth, nickel electrode, and the like, which preferably has a double-layer structure consisting of a hydrophilic side interfaced with the electrolyte 26 and a hydrophobic side interfaced with atmosphere (in the case of acid electrolyte). A hydrophobic material such as polytetrafluoroethylene (PTFE, e.g., Teflon®) may be added to one surface of the cathode layer. The oxidant cathode 24 should be permeable to oxygen gas molecules so that oxygen could migrate to the cathode catalyst layer 34 that promotes Eq.(2) to produce byproduct water. The oxygen cathode should comprise no or little catalyst that can significantly promote oxidation of the dissolved alcohol fuel at the cathode. Preferably, the cathode electro-catalyst 34 should comprise an alcohol-tolerant catalyst. We have found that an alcohol-tolerant oxidant reduction catalyst may be selected from a platinum-chromium alloy, a transition metal mixture or alloy (preferably with a particle size smaller than 2 nm and/or preferably that obtained from transition metal hexacyanometallate) dispersed on carbon black, a carbon-supported iron and/or cobalt, a MoₓRu_{y}Se_{z}—(CO)ₙ carbonyl cluster, a Ru—Se mixed metal, or a combination thereof. Some of these catalysts were originally developed to reduce the mixed potential effect in a conventional DMFC working on a solid acid electrolyte. Our diligent research work has demonstrated that these catalysts are also relatively insensitive to DMFC in liquid acid electrolyte environments and alkaline solution electrolyte environments. They are also found to be relatively insensitive to other alcohols in both liquid acid and alkaline electrolytes. The herein invented dissolved-fuel DAFCs containing an alcohol fuel all are capable of delivering a very impressive power output.

Schematically shown in FIG. 2(a) is a unit cell of the invented DF-DAFC, which typically provides a voltage of 0.4 V to 0.62 V per cell at room temperature and between 0.5 and 0.7 V at higher temperatures (e.g., 50-90° C.). Higher voltages and power densities were observed with 2-propanol- or formic acid-based DF-DAFCs. A voltage as high as 0.94 volts per unit cell was readily achieved with a formic acid system. To provide a higher voltage output, a desired number of unit cells must be connected in series. A compact configuration is to form a stack of several unit cells with the anode (negative electrode) of a first unit cell connected to the cathode (positive electrode) of a second unit cell. The unit cell design as shown in FIG. 2(b) is a particularly good design that provides an oxygen gas flow field plate 28 containing oxygen flow channels 30 that allow oxygen to reach the cathode layer, which is itself permeable to oxygen gas. The oxygen gas has to reach the cathode catalyst layer 34 where the oxygen is reduced according to Eq.(2) or the like. The oxygen gas flow field plate 28 is in direct contact with the oxygen cathode layer and in gas feeding relation to the cathode layer. The oxygen gas flow field plate 28 must be electrically conducting so as to readily transport the electrons that come from the external circuit into the cathode side to reach the interface between the cathode and the electrolyte. The electrolyte-fuel can be fed from a valve 40. It may be noted that this configuration is simpler than that of a stack of conventional PEM-based fuel cell units such as DMFCs. The latter (conventional stack) needs two bipolar plates or two parts of a bipolar plate (one for fuel transport and the other for oxygen) per unit cell while the former needs only one plate or one part for oxygen transport. Unit cells may also be connected in parallel to provide a higher current output. They may also be connected both in series and in parallel.

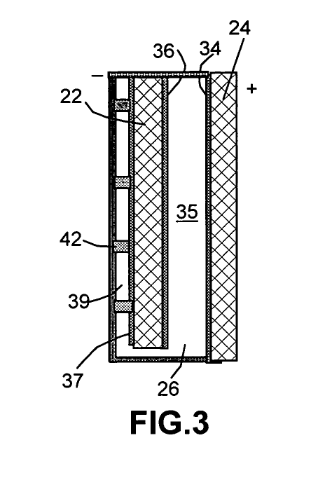

Another preferred embodiment of the present invention, schematically shown in FIG. 3, is a unit cell that contains a fuel anode 22 with both two primary surfaces coated with an anode catalyst 36, 37. This will provide a higher current output since more electrons can be produced and collected per anode layer. This can essentially reduce the required anode layer area (length×width) by a factor of two. This is possible due to the facts that an anode active fuel is dissolved in the electrolyte which flows around both sides of the anode and that the cathode catalyst does not significantly promote fuel oxidation reaction (such as in Eq.(1)) at the cathode side. Provided that a sufficient flow rate of oxygen is supplied to the cathode side (with cathode catalyst 34 coated on the cathode backing layer), the electrochemical reactions can proceed very fast to provide a high current output. An anode current collector 42 is employed to facilitate the transport of electrons and serial connections between unit cells. Dissolved fuel solution 26 (fuel-electrolyte mixture) is present inside both the flow channels 39 of the current collector 42 and the chamber 35 between the anode and cathode. This chamber 35 is preferably contiguous or continuous with the channels 39.

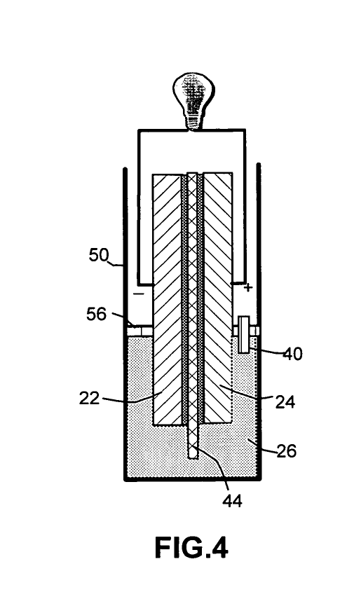

FIG. 4 shows another possible configuration of a unit cell of the presently invented DF-DAFC. The fuel anode 22 and the oxygen cathode 24 are separated by a matrix of highly porous absorbent material 44 that is capable of absorbing the dissolved fuel-containing electrolyte through capillarity pressure from the surrounding electrolyte-fuel solution 26. This matrix of absorbent material 44 also allows ions such as H⁺ (or OH⁻ if the electrolyte contains alkaline solution) to freely pass through. The absorbent materials are very inexpensive, as opposed to proton-exchange membranes such as Nafion which are very expensive. These absorbent materials can be as simple and inexpensive as sponge materials, fiber mats of inexpensive polymers or ceramics, super-absorbent polymers (e.g., those used in a baby diaper or feminine product), or lightly cross-linked polymers commonly used in polymer gels. They simply serve to hold the liquid electrolyte together to prevent over-saturating the cathode pores. They also allow for easy transporting of fuel from a fuel/electrolyte supply into the fuel cell. These materials only occupy a small portion of the electrolyte space where the majority component is the liquid electrolyte-fuel mixture. The proton or ionic conductivity in this essentially liquid electrolyte phase is generally one to several orders of magnitude higher than that in a solid polymer electrolyte such as Nafion. Portions of the electrodes and the entire volume of electrolyte are sealed inside a container 50 by using a proper sealing mechanism 56 that still allows a fuel supply valve 40 to operate. This configuration is very simple and inexpensive to make.

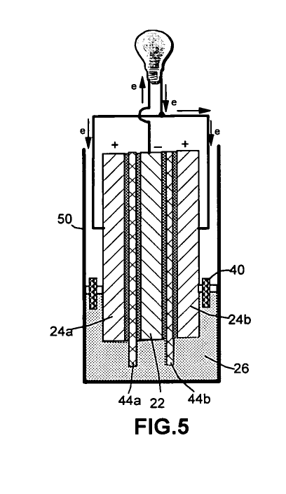

Another attractive design for a unit cell with a high-current output is schematically shown in FIG. 5, wherein two porous and ion-permeating matrix materials 44a, 44b are used to separate a fuel anode 22 and two oxygen cathodes 24a, 24b. Again, the matrix materials are capable of absorbing the fuel-electrolyte mixture 26 via a capillary effect. The fuel anode is essentially sandwiched between the two oxygen cathodes. Electrons are produced at the two catalyst-carrying primary surfaces of the anode 22 and collected by the anode layer to transport to an external load. Electrons come back to the unit cell through both cathode layers 24a, 24b. A fuel reservoir, through a control valve 40, provides and replenishes fuel to the electrolyte continuously or intermittently on demand. The electrolyte is sealed in a container 50, but still allowing sufficient exposed cathode surfaces to access oxygen in the surrounding air. Unit cells of this type, having a high current and high voltage, may be connected in series, in parallel, or both to meet desired current, voltage, and power requirements.

The acid electrolyte may comprise water, an acid, and an alcohol fuel. The acid may be selected from phosphoric acid, sulfuric acid, nitric acid, sulfonic acid, acetic acid, formic acid, hydrogen chloride, and the like. There is no theoretical limitation as to what type of acid that can be used in the present invention as long as it can readily provide hydrogen ions (protons) H⁺. However, some acid (e.g. sulfuric) can be more corrosive than others.

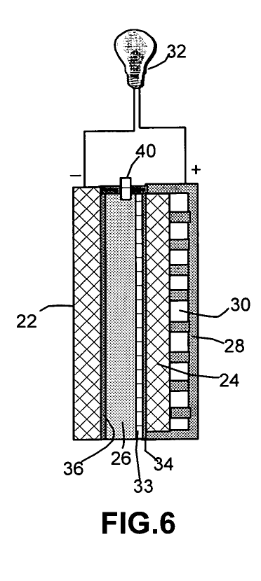

Another preferred embodiment of the present invention is a fuel cell as schematically shown in FIG. 6, wherein the fuel cell further comprises an ion-permeating dense phase 33 in ionic and physical contact with the liquid electrolyte 26 on one side and in ionic communication with the cathode catalyst 34 on the other side of the dense phase. The dense phase preferably comprises an ultra-thin layer of metal hydride or a metal hydroxide with a thickness preferably smaller than 1 μm. This dense phase is permeable to proton or hydroxyl ion but not permeable to the alcohol. The presence of this dense phase significantly reduces or effectively eliminates the alcohol from contacting the cathode catalyst, thereby enabling the use of less alcohol-tolerant catalysts such as less expensive Ni—Co alloys. This dense phase material is not a solid electrolyte that typically requires a certain minimum thickness (typically much thicker than 10 μm and more typically thicker than 100 μm) to prevent mixing between a fuel (e.g., hydrogen gas or methanol) and an oxidant. This is just a thin layer of less expensive material to reduce the presence of alcohol at the cathode side. Since it is ion-conductive and is very thin, it does not significantly add resistance to the system.

The conventional direct methanol fuel cell typically operates on an acid-based solid electrolyte with the electrochemical reactions being summarized in Equations (1)-(3). Contrary to this conventional thinking, we felt that it was not necessary for a dissolved-fuel DMFC to be based on an acidic electrolyte. With a basic or alkaline solution-based electrolyte, the electrochemical reactions occurring in a DMFC (including a DF-DMFC) may be given as follows:

Anode: CH₃OH+6OH⁻→CO₂+5H₂O+6e⁻ (4)

Cathode: 3/2O₂+3H₂O+6e⁻→6OH⁻ (5)

Overall: CH₃OH+3/2O₂→CO₂+2 H₂O (6)

### The overall reaction is identical to that in the acidic electrolyte DMFC, but the product water is produced at the anode instead of cathode.

The electrolyte that can be employed in the present invention may comprise an alkaline solution with pH>7; for example, KOH, NaOH, LiOH, or the like. A chemical species (alcohol fuel) that can react with OH⁻ to produce electrons at the anode is added to the alkaline solution of electrolyte. This fuel may be selected from the group consisting of methanol, ethanol, propanol, 2-propanol (iso-propanol), etc. All members of this group have standard reduction potentials in water that are more negative than the standard reduction potential of a hydrogen electrode in water. They are all good hydrogen-releasing agents that promote anode reactions.

The selection of a fuel to be dissolved in the alkaline electrolyte solution may dictate the types of anode catalyst and cathode catalyst used. The anode catalyst should be selected to promote the anode reaction so that it may proceed at a sufficiently high rate even at ambient temperature or at a temperature not too much higher than the ambient temperature. The cathode catalyst should not promote the fuel oxidation reaction that produces electrons at the cathode, which electrons otherwise would be wasted or produce the mixed potential effect. For instance, platinum is an effective anode catalyst, but platinum alone should not be used at the cathode side. Other oxygen-reducing catalysts (e.g., nanometer-scaled Pt—V, Pt—Cr, and, preferably, Pt-free Ni—Co, Co—Fe, and Ru—Se particles) may be used instead.

Perhaps the most important features of the presently invented alkaline electrolyte-based DF-DAFCs are: (1) obviation of the need to utilize expensive catalysts such as platinum and platinum/ruthenium at the cathode and/or anode; (2) enhanced oxygen reduction kinetics at the cathode in an alkaline electrolyte environment as compared to in an acid environment (with or without Pt); and (3) permission of operating the fuel cell at a much higher temperature for improved electro-chemical reactions at both the anode and cathode. The first feature is significant since the electro-catalyst cost represents a high proportion of a fuel cell system cost. The utilization of platinum-free catalysts could significantly reduce the system cost. The second feature is also significant since cathode reactions are typically much slower than anode reactions in a low-temperature fuel cell (such as the hydrogen/oxygen PEM fuel cell and DMFC) and are the primary sources of over-potential or voltage losses. By using an alkaline electrolyte, the cathode reaction proceeds faster at a given operating temperature and pressure. The third feature allows both anode and cathode reactions to proceed faster, make better utilization of the fuel, and reduce the over-potential, resulting in much improved fuel cell power output. Conventional DMFCs could not be operated at a temperature higher than 80° C. since Nafion-type PEM materials undergo irreversible degradation reactions at elevated temperatures. The presently invented fuel cells eliminate the use of a PEM layer all together and are not subject to such a constraint.

In the case of an acid electrolyte DF-DAFC, the anode preferably includes a backing layer (e.g., carbon paper) and a platinum/ruthenium electro-catalytic film positioned at the interface between the anode backing layer and the electrolyte for promoting oxidation of the methanol fuel. Similarly, the cathode preferably includes a backing layer (e.g., carbon paper or carbon paper surface-treated with a hydrophobic material like Teflon) and a preferably non-platinum-based, alcohol-tolerant electro-catalyst coated on the backing layer. The oxidation or reduction electro-catalyst may be applied directly to the backing layer of its respective electrode or may be dispersed on a suitable catalyst support, such as a carbon, graphite or other electrically conductive support (e.g., nano-scaled carbon particles), which is in turn applied directly to the backing layer of its respective electrode. Most preferred alcohol-tolerant oxidant reduction catalysts are selected from a platinum-chromium alloy, a transition metal mixture or alloy (nano-scaled particles, preferably obtained from transition metal hexacyanometallate) dispersed on carbon black, a carbon-supported iron and/or cobalt, a MoₓRu_{y}Se_{z}—(CO)ₙ carbonyl cluster, a Ru—Se mixed metal, or a combination thereof. Other reduction electro-catalysts known to those skilled in the art, such as sodium platinate, tungsten bronzes, lead ruthenium oxides, lead iridium oxides, lanthanum oxide, and macrocyclic or porphyrin structures containing one or more metals, could also be used.

When a stack of multiple fuel cell units are desired, as is usually the case in real practice, anode catalyst-backing layer 22 may be in contact or integrated with plate 28 of the cathode (e.g., in FIG. 2(b)) to form one thin bi-polar plate, which contains oxidant distribution channels 30. In FIG. 3, plate 42 may be integrated with plate 28 to form one single bipolar plate. A bipolar plate is generally needed between a cathode side of a fuel cell unit and the anode side of another fuel cell unit. For microelectronic device applications, the liquid fuel source may be simple fuel cartridges that are detachable from the fuel cell proper, so that the fuel cell can be run for a prolonged period of time by intermittently replenishing the fuel via replacing the cartridge. For vehicle power applications, the electrolyte-fuel mixture may be circulated between the fuel cell system and a fuel-electrolyte assembly that supplies the fuel-electrolyte mixture. Hence, in another embodiment of the present invention, the fuel cell comprises fuel supply means that include multiple separate chambers or cartridges to accommodate the alcohol fuel (e.g., methanol) and electrolyte solution on a separate basis, not directly as a mixture. At least one chamber is used to accommodate the alcohol fuel and a second chamber is used to house the electrolyte only. This arrangement allows for separate replenishment of fuel and electrolyte. The by-product water generated by the cathode reaction (by the anode reaction with an alkaline electrolyte) can be captured and fed back to the water chamber without varying the alcohol-water ratio in other chambers. Alternatively, water produced at the anode (in the case of alkaline electrolyte) may be allowed to naturally go into the electrolyte-fuel solution, but the electrolyte-fuel concentrations have to be adjusted with from time to time. Sensors may be installed to monitor fuel and/or electrolyte concentrations in real time during the operation of a fuel cell system to help regulate the electrolyte-to-fuel ratio and fuel or electrolyte concentration for the purpose of ensuring stable operation of the fuel cell system.

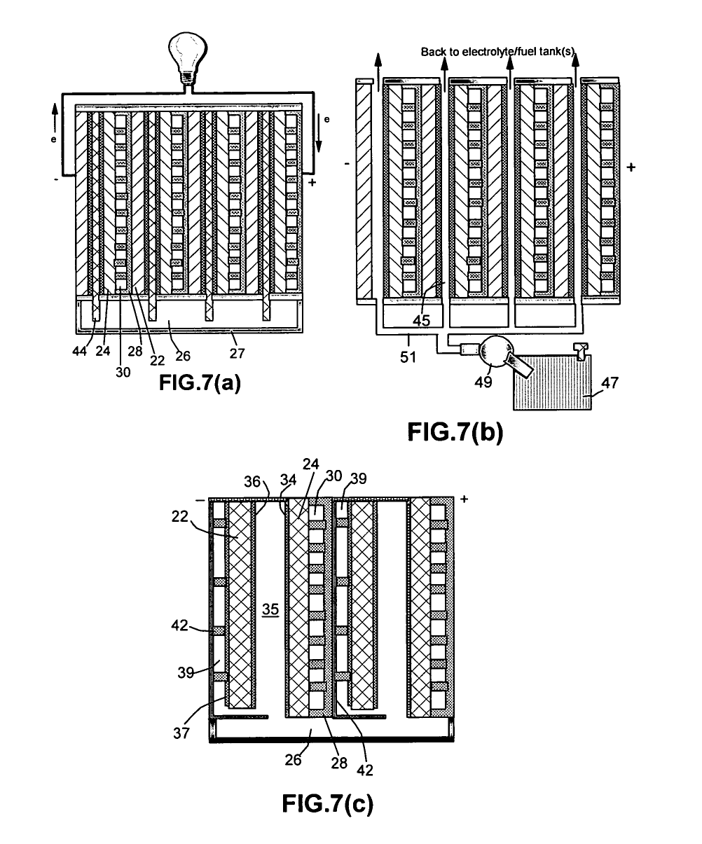

To achieve a desired output voltage level, a number of these unit fuel cells can be stacked together to form a fuel cell assembly. As shown in FIG. 7(a), a number of individual cells can be electrically connected in series by abutting the backing layer (carbon paper) of the anode 22 of one cell with the cathode current collector 28 (containing oxidant flow channels 30) of its nearest neighbor in the stack. At the anode side, the anode catalyst backing layer alone serves as a current collector and no extra uni-polar plate or separator is needed. Each unit cell has a matrix of porous material 44 with capillarity force to drive the electrolyte/fuel 26 from a reservoir or cartridge 27.

In another design (FIG. 7(b)), the fuel/electrolyte may be introduced via a pump 49 through manifolds (e.g., 51) into respective electrolyte/fuel chambers 45 from a fuel/electrolyte reservoir 47. The electrolyte/fuel may be pumped out from another side of the fuel cell stack and returned to the reservoir for refreshing or replenishing treatments. The manifold, pipes, valves, and pump can constitute a re-circulation loop. A fuel or electrolyte concentration sensor may be used to monitor the fuel-electrolyte compositions as a function of time.

In another embodiment of the present invention, as schematically shown in FIG. 7(c)), the individual unit cells may comprise an anode backing layer 22 with both two primary surfaces coated with an anode catalyst 36, 37 (as illustrated earlier in FIG. 3 earlier). Dissolved fuel solution 26 (fuel-electrolyte mixture) is present inside both the flow channels 39 of the anode current collector 42 and the chamber 35 between the anode and the cathode (with alcohol-tolerant catalyst 34 coated on a carbon backing layer 24). This cathode backing layer 24 is in electronic contact with an electrically conductive separator member (oxidant distribution plate) 28 that contains oxidant flow channels 30. The cathode separator member 28 of a fuel cell unit may be combined with the anode current collector 42 (or fuel distribution plate) of another fuel cell unit to become an integrated bipolar plate. Fuel cell as schematically shown in FIG. 7(c) provides a higher current and power output (almost doubled) given the same number of cathodes and the same cathode layer area.

In a conventional fuel cell stack design, stacking and porting unit fuel cells may require complex flat stack arrangements and involve numerous parts (e.g., membranes, gaskets, bipolar plates with flow channels, and solid electrode layers) that may be difficult and expensive to fabricate and assemble. Traditional fuel cell stacks are highly prone to catastrophic failure of the entire system if a leak develops. The cost of fabricating and assembling fuel cells is significant, due to the materials and labor involved. In addition, it is difficult to transport the oxygen and fuel through the traditional stack, and increased gas or liquid transport requires pressurization, with attendant difficulties.

An alternative style of fuel cell has been recently proposed (e.g., Binder, et al., U.S. Pat. No. 5,783,324, Jul. 21, 1998 and Pratt, et al., U.S. Pat. No. 6,127,058, Oct. 3, 2000), which is a side-by-side configuration in which a number of individual cells are placed next to each other in a planar arrangement. This is an elegant solution to the problem of gas and fuel transport and mechanical hardware. However, a planar fuel cell configuration based on the conventional direct methanol fuel cell (DMFC) approach is still subject to the same drawbacks associated with all DMFCs (e.g., complex configuration or too many layers in a unit, expensive PEM, expensive platinum catalysts, etc.). An improved planar fuel cell that is less complex and can be made at a lower cost would be a significant addition to the field.

Hence, another preferred embodiment of the present invention is a planar or co-planar fuel cell configuration that features the alcohol-tolerant cathode catalysts described above. A co-planar fuel cell, also referred to as a strip or segmented fuel cell, comprises several series-connected cells that are fabricated on the same continuous, planar layer or pool of liquid electrolyte-fuel mixture. Alternatively, separate layers or pools of a liquid electrolyte-fuel mixture, together with an anode on one side thereof and a cathode on the opposite side thereof, may be used for each cell.

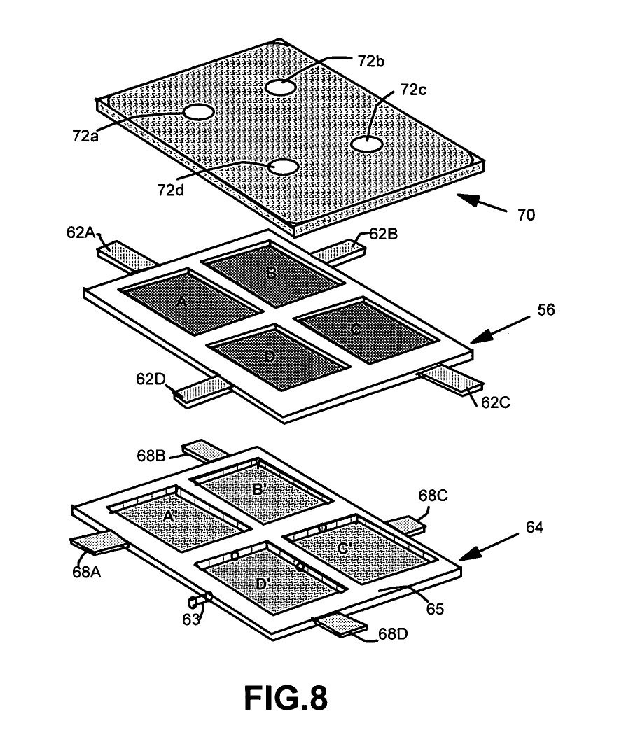

In a planar fuel cell (e.g., FIG. 8), several cathodes A, B, C, and D are arranged on a planar cathode assembly 56. Below the cathode assembly 56 is an anode assembly 64 that comprises a plurality of anodes A′, B′, C′, and D′ corresponding to A, B, C, and D, respectively. Between cathodes A, B, C, and D and corresponding anodes A′, B′, C′, and D′ (and above A′, B′, C′, and D′ as shown in the lower portion of FIG. 8) are chambers to accommodate the liquid electrolyte/fuel. These chambers may be interconnected (in fluid communication with one another) or contiguous with one another. They could be just one big pool of electrolyte-fuel mixture. If they are not interconnected, each chamber contains flow channels (or tubings) that receive fuel and electrolyte from a fuel/electrolyte supply (e.g., a reservoir or cartridge). If they are interconnected, one or two channels or tubings (e.g., 63) are provided to be in flow communication with a fuel/electrolyte reservoir, cartridge, or re-circulating pump. Air or oxygen is naturally supplied from the top of a cover or casing 70 through one or more air access holes (e.g., 72a, 72b, 72c, and 72d). The cathodes are exposed to the air, and air flow is achieved preferably by natural convection (e.g., for portable devices) or by use of a low pressure fan, blower or pump (e.g., for vehicles). It is important to recognize that oxygen is more readily available to the cathodes in this planar fuel cell system compared to a traditional fuel cell stack where air or oxygen feeds sideways through the channels of a bipolar plate (which is more difficult and may require a fan to blow air into the bipolar plates if the fuel cell active areas are large). The presently invented planar fuel cell system does not need bipolar plates which typically occupy a majority (up to 90%) of the volume or thickness of a conventional fuel cell stack.

Edge current collection wires or cell interconnects are used to connect the individual cells in electrical series. Alternatively, cells or groups of cells may be connected in parallel. The anode and cathode catalyst backing layers (sheets of carbon paper or graphite fiber cloth) may perform additional functions such as serving as current collectors (or electron transporters). The anode assembly 64 consists of an electrically insulating plastic frame 65 that contains a plurality of current collectors (i.e., backing layers for anodes A′, B′, C′, and D′) embedded within the plastic frame. Each of the current collectors has an interconnect means (e.g., 68A, 68B, 68C, 68B) appended thereto. As shown in FIG. 8, each cathode (comprising preferably a carbon paper or cloth as a catalyst backing layer) has a tab (e.g., 62A, 62B, 62C, and 62B) connected thereto or integral therewith. The interconnect means serves to make an electrical connection to the exterior of the fuel cell, and is electrically connected to the current collector (carbon paper). Although the drawing depicts the interconnect means (e.g. 68A) as a tab, it can assume a variety of configurations, for example, a wire, as will be readily discernible to one of ordinary skill in the art.

In one preferred embodiment, the current collectors can be insert-molded into the plastic frame 65 with the interconnect means extending through the frame such that when the planar fuel cell is assembled, the current collector is within the perimeter of the assembly and the interconnect means is outside the perimeter of the assembly. One main advantage of this format is that the plastic frame 65 forms a gas tight integral seal around the interconnect means, thus eliminating the need to add other seals and/or gaskets. This novel approach provides for electrical connections between and within the fuel cell without traversing the thickness of the solid electrolyte sheet. No penetrations are made in the assembly, thus the liquid electrolyte chambers can be made in a single, continuous frame. There are no holes or apertures to seal, as in the prior art. This novel scheme allows the individual anodes and cathodes in each of the arrays to be placed very close together, thus utilizing a greater amount of the active area, as high as 95% of the total area of the current collector assembly. The individual anodes or cathodes can be spaced as close as 1 mm to each other. The feature that the electrolyte and fuel are mixed together further reduces the bulkiness of the fuel cell assembly system.

A conventional planar fuel cell is typically composed of a membrane electrode assembly (MEA) sandwiched between two current collector assemblies. By contrast, in one embodiment of the present invention, no current collector assembly or only one assembly is needed, significantly reducing the bulkiness and complexity of the fuel cell system. The current collectors may be supported by a plastic frame, and they have an interconnect tab that provides an electrical pathway beyond the perimeter of the assembly. The interconnect tab can be connected to or integral with the corresponding anode or cathode. The interconnect tab is situated to provide electron transfer between the anodes and the cathodes such that preferably the interconnect tab does not traverse the thickness of the liquid electrolyte chambers. When the planar fuel cell is assembled, the interconnect tab is properly sealed to prevent leaking of fuel/electrolyte. The presently invented planar fuel cell system has fewer parts, fewer layers, and lesser degree of complexity in design compared to those proposed by Binder, et al. (U.S. Pat. No. 5,783,324, Jul. 21, 1998) and Pratt, et al. (U.S. Pat. No. 6,127,058, Oct. 3, 2000).

### EXAMPLE 1

### Preparation of Alcohol-Tolerant Cathode Catalysts, Including Pt₃Cr and Pt—V Alloys (Pt₃V or Pt₅V) and Other Noble Metal-Transition Metal Alloys

One preferred class of the alcohol-tolerant electro-catalysts used in the present study was platinum-chromium or platinum-vanadium catalysts supported on carbon black.

Nano-scaled platinum-chromium alloy catalyst particles supported on carbon were prepared in the following manner: 20 grams of platinum-on-carbon-black (containing 10% platinum by weight) was dispersed in 1,000 ml of water followed by ultrasonic blending for 30 minutes. The pH of the solution was then raised to 8 with dilute ammonium hydroxide solution to counter the natural acidity of the supported catalyst. Stirring continued during and after pH adjustment. A solution of 12 g of ammonium chromate in 100 ml of water was then added to the pH adjusted solution. Following addition of the complete 100 ml of solution, dilute hydrochloric acid was added to the solution until a pH of 5.5 was attained to cause the adsorption of the chromium species on the supported catalyst. Stirring continued for one hour. After filtering, the solids were dried at 90° C. and sifted through a 100 mesh screen. The sifted solid was then heat-treated at 900° C. in flowing nitrogen for one hour to form the platinum-chromium alloy catalyst (particle sizes typically smaller than 1.2 nm). Graphitized Vulcan XC-72 (Cabot Corporation) was used in this Example, but other carbons in the graphitized or ungraphitized form or acetylene black could also be used as support material. X-ray diffraction data on the formed catalysts indicated that the alcohol-tolerant cathode catalysts developed were Pt—Cr alloys with up to about 30 atomic percent of chromium in the alloy. The alloy preferably has about 25 atomic percent of chromium.

As another example, one gram of V₂O₅ in 250 ml distilled water was dissolved by the addition of 1 N NaOH to bring the pH to 9. The dissolution rate was accelerated by heating the solution. The solution was chilled to 5-10° C. and 2 ml of 30 volume percent H₂O₂ and 15 ml of 4 weight percent Na₂S₂O₄ were added into this solution. After a few minutes of mixing, the pH of this solution was decreased to about 1.5 by the addition of cold 1 N HCl. This solution had a light yellow, clear appearance that changed to a clear but very dark black-green color (believed to be V⁺³ sulfite complex) upon extended (longer than 30 minutes) stirring.

Meanwhile, in a separate beaker, twenty grams of catalyst consisting of 10% Pt by weight supported on carbon black was ultrasonically dispersed in 800 ml distilled water and cooled to 5-10° C. The surface area of this catalyst was 110 m²/g Pt or greater. The two suspensions were mixed together and stirred for a sufficient length of time (about one hour) for the V⁺³ sulfite complex to adsorb on the carbon black support in an appreciable quantity (about 50 atom percent vanadium based on platinum). The vanadium complex impregnated catalyst was then filtered and dried to obtain an intimate mixture of a highly dispersed vanadium complex and highly dispersed platinum on carbon. The mixture was then heated to 930° C. in flowing N₂ (or H₂) and held at this temperature for one hour. The product was cooled to room temperature before exposing it to atmospheric air. The Pt—V alloys were in the form of ultra-fine particles with particle size typically smaller than 1.5 nm. Similar procedures can be used for the preparation of other nano-scaled, noble metal-transition metal catalyst particles of Pt—Ti/C, Pt—Si/C, Pt—Al/C, Pt—Cr—Al/C, Pt—Ce/C (C=carbon support).

Zhu, et al. (U.S. Pat. No. 7,014,931, Mar. 21, 2006) disclosed that selected Pt—Cr alloys were methanol-tolerant in a solid acid electrolyte environment (e.g., using Nafion as the PEM). However, they did not recognize that Pt—Cr was also methanol-tolerant in an alkaline electrolyte environment. Nor did they recognize that Pt—Cr was relatively insensitive to other alcohols than methanol. Furthermore, they disclosed a conventional DMFC using Pt—Cr as a cathode catalyst, as opposed to the presently invented dissolved-fuel DMFC.

### EXAMPLE 2

### Preparation of Anodes and Cathodes for Fuel Cells

As an example, the carbon-supported platinum-chromium catalysts used in the present study contained about 30-44 wt % platinum-chromium. The corresponding anode catalyst was a PtRu/C (45 wt %). The anode and cathode catalysts were dispersed in appropriate amounts in water, with an added perfluorinated ion exchange polymer for ionic conduction adjacent the catalysts (e.g., 5% Naflon® solution) and for binding catalyst particles to carbon paper. Exemplary cathode ink compositions were 65 wt % Pt/C and 35 wt % Nafion® (for comparison) and 66 wt % Pt₃Cr/C and 34 wt % Nafion®. The anode ink compositions were 85 wt % PtRu and 15 wt % Nation® or 70 wt % PtRu/C and 30 wt % Nafion®. The electrodes were prepared by painting the catalytic inks on sheets of carbon paper. The cathode catalyst inks were applied to obtain an experimental loading of about 0.6 mg/cm². In all cases the geometric active area of the catalyzed electrode was 5 cm². The anode catalyst used in the present study as primarily Pt/Ru supported on carbon black. However, in the cases of formic acid-based DD-DAFC, carbon supported palladium nano particles (alone or in combination with Pt) were also used.

### EXAMPLE 3

### Carbon Black-Supported Cobalt-Iron Nano Particles as Cathode Catalysts

Another class of alcohol-tolerant oxygen reduction catalysts can be prepared by dispersing a series of transition metal hexacyanometallates on carbon black (CB) and heat-treating the mixture at several temperatures under a nitrogen atmosphere. The precursors were prepared by adding 0.03 M M′SO₄ (M′=Mn, Fe, Co, Ni, and Cu) aqueous solution into stirring dispersion of CB in 0.02 M K₃M″(CN)₆ (M″=Fe, Co) solution. The procedures were similar to those suggested by Sawai, et al., (J. of the Electrochemical Soc., 151 (5) (2004) A682-A688). In the present example, the catalysts used were obtained primarily from the groups with M′=Fe, Co, and Ni, and M″=Fe and Co. The loaded amount of the Prussian blue analogs (PB) was about 5×10⁻⁴ mol on 0.1 g of CB. The resulting mixture was filtrated with a filter paper, washed with distilled water several times, and dried in an oven at 80° C. The dried sample was wrapped with a copper foil, heated to the preset temperature at a heating rate of about 200°/h in a horizontal quartz tube under a nitrogen atmosphere, followed by keeping the sample at the preset temperature for approximately 10 min. It may be noted that a gas containing toxic HCN was evolved when heating the hexacyanometallate salt. Hence, HCN in the gas was collected in a gas washing bottle and the cyanide ion was decomposed by a sodium hypochlorite (NaClO) solution. The heat-treated sample was kept in a desiccator over blue silica gel until use. The particle sizes were typically between 0.5 nm and 2 nm.

Sawai, et al. observed that these catalysts were insensitive to methanol. We have found that they were also insensitive to other alcohols such as ethanol, propanol, and iso-propanol in both acid and alkaline electrolyte environments. In an acid electrolyte, they were also formic acid-tolerant when used as a cathode catalyst in the presently invented dissolved-fuel direct alcohol fuel cell.

### EXAMPLE 4

### Ruthenium Chalcogenides as Cathode Catalysts

A pre-treated carbon black sample was impregnated with RuCl₃-xH₂O solution (with 30% by weight metal content). Upon removal of the solvent, the dried powder was treated under hydrogen at 200° C. The resulting material was then dispersed or immersed in a H₂SeO₃ solution. After filtration and drying steps, the powder was annealed in a hydrogen environment at 300° C. for 60 minutes to obtain RuSeₓ (with Se varied preferably between 5 to 20%). The particle size was found to be below 2 nm.

### EXAMPLE 5

### Comparison of Fuel Cell Performance

A comparison was made between dissolved-fuel direct methanol fuel cells (Fuel Cell-A: DF-DMFC containing methanol-tolerant Pt/Cr cathode catalyst), conventional DMFC (Fuel Cell-B: containing no methanol-tolerant cathode catalyst), and DF-DMFC (Fuel Cell-C: containing conventional Pt cathode catalyst). The anode and cathode were made by the procedures illustrated in Example 2. The electrolyte-fuel mixture used was methanol-water-nitric acid at a molar ratio of 0.5:1.0:0.1 for both Fuel Cell-A and Fuel Cell-C. For Fuel Cell-B, the fuel was methanol-water at a molecular ratio of 0.5:1.0 and the electrolyte was solid Nafion.

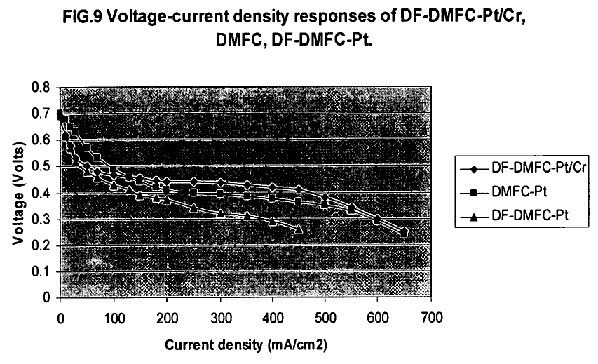

FIG. 9 shows the voltage-current density responses of the three fuel cell units. It is of interest to observe that Fuel Cell-A (a DF-DMFC containing methanol-tolerant Pt/Cr cathode catalyst prepared in Example 1) shows a faster drop in voltage at low current densities compared to a corresponding Fuel Cell-B (containing no methanol-tolerant cathode catalyst, only conventional Pt). This could imply that the DF-DMFC, with the presence of methanol at the cathode side, did require higher activation overpotential when the external circuit demanded a lower current density. However, over a wide range of intermediate current densities, Fuel Cell-A exhibits a consistently higher working voltage at a given current density compared to Fuel Cell-B (0.45 V as opposed to 0.4 V) at an operating temperature of 60° C. This might be ascribed to a much higher ion conductivity associated with a liquid electrolyte (as opposed to a solid electrolyte) and, hence, a much lower Ohmic loss. This is an important advantage since, in practice, it is this stable working voltage range that most of the fuel cells are designed to operate in, rather than the highest and lowest voltage ends of the curve. In contrast, for Fuel Cell-C, the DF-DMFC without a methanol-tolerant cathode catalyst (Pt only), exhibits an inferior voltage-current response.

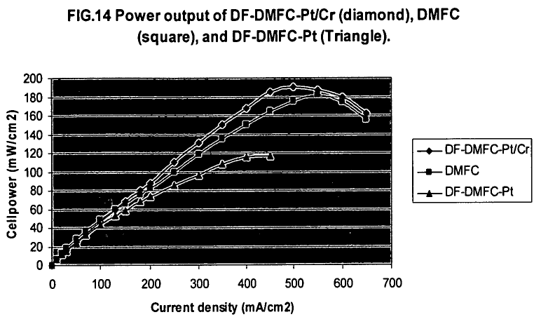

The corresponding power density curves for these three fuel cells are shown in FIG. 14, which demonstrates that a power density as high as 190 mW/cm² can be achieved with the presently invented dissolved-fuel DMFC. This is slightly better than what is achievable with a conventional DMFC (which is more expensive and complex).

### EXAMPLE 6

### Performance Comparison between a Dissolved-Fuel Direct Methanol Fuel Cell with Acid Electrolyte and One with an Alkaline Electrolyte

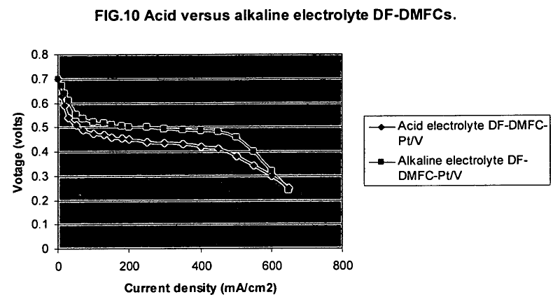

A comparison was made between an acid-electrolyte dissolved-fuel direct methanol fuel cell (Fuel Cell-D: DF-DMFC containing methanol-tolerant Pt/V cathode catalyst) and an alkaline solution electrolyte DF-DMFC (Fuel Cell-E: containing Pt/V cathode catalyst). The electrolyte-fuel mixture used was methanol-water-nitric acid at a molar ratio of 0.5:1.0:0.1 for Fuel Cell-D and that for Fuel Cell-E was methanol-water-KOH at a molar ratio of 0.5:1.0:0.2. FIG. 10 shows the voltage-current density responses of the two fuel cell units operated at 80° C. It is clear that Fuel Cell-E (an alkaline electrolyte-based DF-DMFC) exhibits a consistently higher voltage response than its acid electrolyte counterpart. A stable working voltage of approximately 0.5 volts was achieved with the alkaline electrolyte-based DF-DMFC.

### EXAMPLE 7

### Performance Comparison between a Dissolved-Fuel Direct Ethanol Fuel Cell (DF-DEFC) with Acid Electrolyte and One with an Alkaline Electrolyte

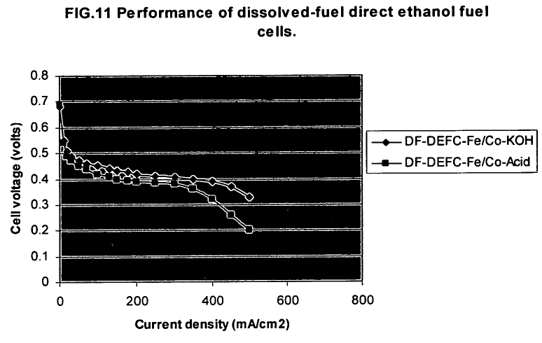

A comparison was made between an acid-electrolyte dissolved-fuel direct ethanol fuel cell (Fuel Cell-F: DF-DEFC containing Fe/Co cathode catalyst obtained in Example 3) and an alkaline solution electrolyte DF-DEFC (Fuel Cell-G: containing Fe/Co cathode catalyst). The electrolyte-fuel mixture used was ethanol-water-nitric acid at a molar ratio of 0.5:1.0:0.1 for Fuel Cell-F and that for Fuel Cell-G was ethanol-water-KOH at a molar ratio of 0.5:1.0:0.2. FIG. 11 shows the voltage-current density responses of the two fuel cell units operated at 80° C. It is clear that Fuel Cell-G (an alkaline electrolyte-based DF-DEFC) exhibits a consistently higher voltage response than its acid electrolyte counterpart. This is again a highly surprising result. A stable working voltage of approximately 0.41 volts was achieved with the alkaline electrolyte-based DF-DEFC. Both fuel cell units perform reasonably well, demonstrating that carbon-supported nano-scaled Fe/Co particles are relatively ethanol-tolerant.

### EXAMPLE 8

### Performance of a Dissolved-Fuel direct 2-propanol Fuel Cell (DF-D2PFC) with Acid Electrolyte

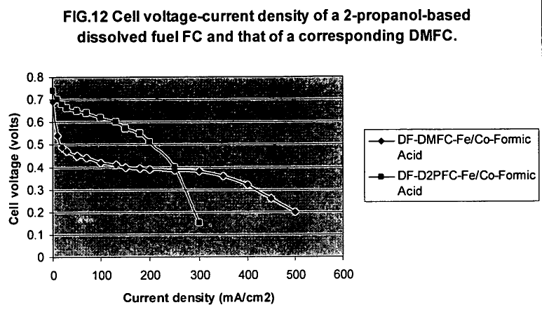

A comparison was made between an acid-electrolyte dissolved-fuel direct 2-propanol fuel cell (Fuel Cell-H: DF-D2PFC containing Fe/Co cathode catalyst obtained in Example 3) and a corresponding DF-DMFC (Fuel Cell-I: containing Fe/Co cathode catalyst). The electrolyte-fuel mixture used was 2-propanol-water-formic acid at a molar ratio of 0.5:1.0:0.1 for Fuel Cell-H and that for Fuel Cell-I was methanol-water-formic acid at a molar ratio of 0.5:1.0:0.1. FIG. 12 shows the voltage-current density responses of the two fuel cell units operated at 60° C. The DF-D2PFC exhibits a much better performance than its DMFC counterpart at current densities less than 250 mA/cm². It has a higher open circuit voltage to begin with.

The anode fuel oxidation reaction for 2-praponol may be given in Equation (7):

CH₃CHOHCH₃+5H₂O→3CO₂+18H⁺+18e⁻ (7)

For each 2-propanol molecule oxidized at the anode, 18 electrons are produced. In contrast, Equation (1) shows that for each methanol molecule oxidized at the anode, 6 electrons are produced. The molecular mass of 2-propanol (60.10 g/mol) is less than double that of methanol (32.04 g/mol). Further, the two fuel species have very similar physical densities (0.785 g/cm³ for 2-propanol vs. 0.791 g/cm³ for methanol). The electrochemical energy density of 2-propanol is more than 1.5 times that of methanol per unit mass or per unit volume, provided that the fuel is completely oxidized. In the near future when more effective electro-catalysts become available, 2-propanol will become a highly viable fuel for DF-DAFC cells.

### EXAMPLE 9

### Performance of a Dissolved-Fuel DAFC with Formic Acid as Both the Electrolyte and the Primary Fuel Component

Instead of Pt or Pt/Ru, palladium nano-particles were found to be more effective anode catalyst for direct formic acid fuel cell using formic acid (FA) as the fuel fluid at the anode side and a solid polymer (Nafion) as the electrolyte interposed between a cathode and an anode (Masel, et al., US Pat. No. 2005/0136309 (Pub. Date: Jun. 23, 2005)). Masel's fuel cell still employs a solid electrolyte. In contrast, in our DF-DAFC, liquid formic acid was interposed between the anode and cathode as both the electrolyte and the fuel.

A chemical reduction method was employed to make the palladium nano-particle catalyst. The multi-step procedure included (1) dispersing carbon black particles in deionized water in an ultrasonic bath, (2) adding a reducing agent solution (sodium formate) and a metal precursor solution (palladium nitrate) into the carbon black suspension while under sonication at 45-75° C., and (3) forming palladium nanoparticles on the nano-scaled carbon black surface. The anode and cathode catalyst inks were prepared by mixing appropriate amounts of catalyst powders with 5% recast Nafion solution. Both the anode and cathode inks were applied onto one side of a carbon paper. Nafion was used to bind the catalyst particles to the carbon paper surface. The palladium particles at the anode had particle sizes smaller than 3 nm. The cathode catalyst was RuSeₓ (with approximately 15% Se) as prepared in Example 4.

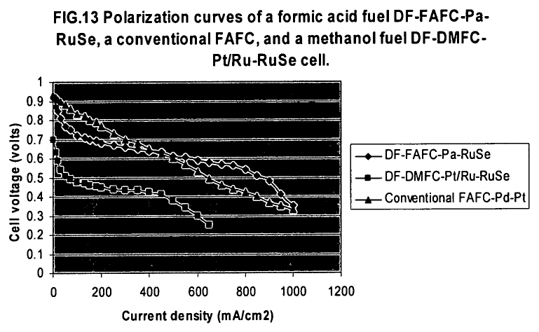

A comparison was made between a dissolved-fuel formic acid fuel cell (Fuel Cell-J: DF-FAFC containing RuSeₓ cathode catalyst obtained in Example 4 and carbon-supported palladium anode catalyst), a conventional FAFC with a Nafion PEM (Fuel Cell-K: containing RuSeₓ cathode catalyst obtained in Example 4 and carbon-supported palladium anode catalyst), and a DF-DMFC (Fuel Cell-L: containing RuSeₓ cathode catalyst and Pt/Ru anode catalyst). The electrolyte-fuel mixture used was formic acid-water at a FA concentration of 2M for Fuel Cell-J and that for Fuel Cell-L was methanol-water-formic acid at a molar ratio of 0.5:1.0:0.1 (formic acid serving primarily as electrolyte). For the conventional FAFC, the formic acid (2 M) was fed into the anode side as a liquid fuel while the anode and cathode are separated by a Nafion membrane. FIG. 13 shows the voltage-current density responses of the three fuel cell units operated at 50° C. Both the DF-FAFC and the conventional FAFC with Pd anode catalysts exhibit much better performance than the DF-DMFC. Both the DF-FAFC and the conventional FAFC exhibit a higher open circuit voltage (approximately 0.92 V) than DF-DMFC (0.69 V).

A comparison between the presently invented DF-FAFC and the conventional FAFC indicates that the conventional FAFC has a higher voltage (lower activation overpotential) when the external circuit demands a current density less than 400 mA/cm². When the required current density exceeds 400 mA/cm², the DF-FAFC is capable of maintaining a higher voltage. It is of further interest to note that the presently invented DF-FAFC provides a relatively high, stable working voltage (>0.6 volts) over a very broad current density range (200-600 mA/cm²). This was achieved without having to use an expensive solid electrolyte membrane like Nafion, without expensive Pt-based catalyst, and with a simpler fuel cell design as compared to the conventional formic acid fuel cell (e.g., that developed by Masel, et al.) or DMFC.

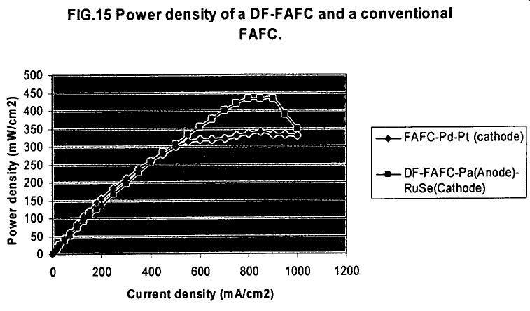

The corresponding power density curves for both the DF-FAFC and the conventional FAFC are shown in FIG. 15, which demonstrates that a power density as high as 430 mW/cm² can be achieved with the presently invented dissolved-fuel formic acid fuel cell. This is due to the intrinsically high theoretical open circuit voltage (1.45 volts) associated with the following anode reaction:

HCOOH→CO₂+2H⁺+2e⁻ (7)

This is in contrast to 1.2 volts for the corresponding methanol-water reaction. The notion that DF-FAFC is capable of maintaining a relatively high, stable working voltage (>0.6 volts) over a very broad current density range also contributes to this exceptionally high power density.

### EXAMPLE 10

### Liquid Electrolyte-Absorbing Materials

Polyurethane (PU) was prepared by the reaction of toluene-2,4-diisocyanate with hydroxy-terminated oligomers. Oligomers were either liquid polybutadiene (MW 3000) or propylene oxide-based polyethers (MW 420 and 4800). Polyurethanes with linking segments formed predominantly by high-molecular-weight oligomers (MW 3000 or 4800) were rubbery materials with a glass transition temperature (Tg) lower than room temperature.

Cross-linked poly (vinyl alcohol) (PVA) material was prepared with poly (acrylic acid-co-maleic anhydride) (PAAM) serving as a polymeric cross-linking agent. Cross-linked materials were characterized by good water and methanol-retaining capabilities. Swelling ratio decreased with increasing cross-linking agent content since the swelling of water molecule is restricted by chemical cross-linking between PVA chains and polymeric cross-linking agent chains and physical cross-linking by entanglement between the chains. Both PU and cross-linked PVA were found to be particularly suitable for use as a electrolyte/fuel-retaining material. They did not show any significant sign of degradation after being impregnated with the liquid electrolyte/fuel for five months. They were used to prevent electrolyte from over-flooding the cathode pores. Both protons and hydroxyl ions are able to freely move through the retained electrolyte with an ionic conductivity being at least one to two orders of magnitude greater than in solid Nafion.

1. A dissolved-fuel direct alcohol fuel cell comprising:
a) a fuel anode;
b) a first oxidant cathode comprising an alcohol-tolerant oxidant reduction catalyst;
c) a liquid electrolyte in ionic contact with said anode and said first cathode, said electrolyte comprising a solution and an alcohol fuel dissolved in said solution.

2. The fuel cell as defined in claim 1, wherein said alcohol fuel is selected from the group consisting of methanol, ethanol, propanol, butanol, 2-propanol, formic acid, and combinations thereof.

3. The fuel cell as defined in claim 1, wherein said electrolyte solution comprises an acid or an alkaline solution.

4. The fuel cell as defined in claim 1, wherein said electrolyte solution comprises an alkaline selected from the group consisting of KOH, NaOH, LiOH, and combinations thereof.

5. The fuel cell as defined in claim 1, wherein said electrolyte solution comprises an acid selected from phosphoric acid, sulfuric acid, sulfonic acid, nitric acid, formic acid, hydrogen chloride, or a combination thereof.

6. The fuel cell as defined in claim 1, wherein said electrolyte solution comprises an alkaline solution and said alcohol fuel comprises methanol, ethanol, or 2-propanol.

7. The fuel cell as defined in claim 1, wherein said liquid electrolyte is retained by a matrix of porous material.

8. The fuel cell as defined in claim 1, wherein said alcohol-tolerant oxidant reduction catalyst comprises a catalyst selected from a platinum-chromium alloy, a platinum-vanadium alloy, a transition metal mixture or alloy dispersed on carbon, a carbon-supported iron and/or cobalt, a MoₓRu_{y}Se_{z}—(CO)ₙ carbonyl cluster, a Ru—Se mixed metal, or a combination thereof.

9. The fuel cell as defined in claim 1, further comprising electrolyte-fuel supply/treatment means for feeding, replenishing, retrieving, circulating, or refreshing said electrolyte-fuel solution.

10. The fuel cell as defined in claim 1, further comprising a fuel or electrolyte concentration sensor.

11. The fuel cell as defined in claim 9, wherein said electrolyte-fuel supply/treatment means comprise a pump means to transport the electrolyte-fuel solution.

12. The fuel cell as defined in claim 1, further comprising an ion-permeating dense phase in physical and ionic contact with said liquid electrolyte on one side of said dense phase and in ionic communication with said cathode catalyst on another side.

13. The fuel cell as defined in claim 12, wherein said dense phase comprises a metal hydride or a metal hydroxide.

14. The fuel cell as defined in claim 12, wherein said dense phase is permeable to proton or hydroxyl ion but not permeable to said alcohol fuel.

15. The fuel cell as defined in claim 1, wherein said first oxidant cathode comprises a carbon paper, a carbon cloth, a nickel electrode, or a combination thereof.

16. The fuel cell as defined in claim 15, wherein said first oxidant cathode further comprises a hydrophobic material.

17. The fuel cell as defined in claim 1, further comprising a second oxidant cathode in ionic contact with said electrolyte, wherein said fuel anode is sandwiched between said first oxidant cathode and said second oxidant cathode.

18. The fuel cell as defined in claim 1, wherein said fuel anode comprises a non-platinum catalyst.

19. The fuel cell as defined in claim 1, further comprising an oxygen gas flow field plate in contact with said first oxygen cathode and in gas feeding relation thereto.

20. The fuel cell of claim 1 wherein said electrolyte solution comprises formic acid as both a primary fuel and an electrolyte.

21. The fuel cell of claim 20 which delivers a power density of no less than 400 mW/cm².

22. The fuel cell of claim 1 wherein said fuel anode comprises palladium as a catalyst element and said electrolyte comprises formic acid.

23. A stack of multiple fuel cells connected in series, in parallel, or in a combination of serial and parallel connections, wherein at least one fuel cell is as defined in claim 1.

24. A planar fuel cell system, comprising a planar array of liquid electrolyte chambers containing a liquid electrolyte therein, having a plurality of anodes disposed on one major side of said liquid electrolyte and a plurality of corresponding cathodes disposed on an opposing major side of said liquid electrolyte, wherein
(a) said cathodes comprise an alcohol-tolerant catalyst;
(b) said liquid electrolyte is in ionic contact with both said anodes and said cathodes and said electrolyte comprises a solution and an alcohol fuel dissolved in said solution; and
(c) a plurality of current collectors each having an interconnect means, wherein each of the plurality of anodes or each of the plurality of cathodes has one of said plurality of current collectors associated therewith, the interconnect means being arranged to provide electron transfer between anodes and cathodes.

25. The planar fuel cell system as described in claim 24, wherein the electron transfer between anodes and cathodes forms a series circuit.

26. The planar fuel cell system as described in claim 24, further comprising fuel-electrolyte supply means in feeding relation to said liquid electrolyte chambers.

27. The planar fuel cell system as described in claim 26, wherein said fuel-electrolyte supply means comprises a plurality of separate channels to accommodate and supply said electrolyte and fuel to said electrolyte chambers.

28. The planar fuel cell system as defined in claim 24, wherein said alcohol-tolerant oxidant reduction catalyst comprises a catalyst selected from a platinum-chromium alloy, a platinum-vanadium alloy, a transition metal mixture or alloy dispersed on carbon black, carbon-supported iron and/or cobalt, a MoₓRu_{y}Seₓ—(CO)ₙ carbonyl cluster, a Ru—Se mixed metal, or a combination thereof.

29. The planar fuel cell system as defined in claim 24, wherein at least one of said anodes comprises an electrically conducting backing layer with two major surfaces coated with an anode catalyst.

30. The planar fuel cell system as defined in claim 24, wherein said alcohol fuel is selected from the group consisting of methanol, ethanol, propanol, butanol, 2-propanol, formic acid, and combinations thereof.

31. The planar fuel cell system as defined in claim 24, wherein said electrolyte solution comprises an acid or an alkaline solution.

32. The planar fuel cell system as defined in claim 24, wherein said electrolyte solution comprises formic acid.

33. The planar fuel cell system as defined in claim 24, wherein said electrolyte solution comprises formic acid and said fuel anode comprises palladium.

34. The planar fuel cell system as defined in claim 24, wherein said electrolyte solution comprises an alkaline solution and said alcohol fuel comprises methanol, ethanol, or 2-propanol.

35. The planar fuel cell system as defined in claim 24, wherein said liquid electrolyte is retained by a matrix of porous material.
